(19) United States
(12) Patent Application Publication
(10) Pub. No.: US 2026/0126121 A1
(43) Pub. Date: May 7, 2026

(54) NON-RETURN VALVE, IN PARTICULAR FOR A REFRIGERATION OR HEAT CIRCUIT

(71) Applicant: OTTO EGELHOF GmbH & Co. KG, Fellbach (DE)

(72) Inventors: Eike Willers, Stuttgart (DE); Andreas Auweder, Vaihingen (DE)

(21) Appl. No.: 19/118,126

(22) PCT Filed: Sep. 28, 2023
(86) PCT No.: PCT/IB2023/059696

§ 371 Date: Apr. 3, 2025

(30) Foreign Application Priority Data
Oct. 4, 2022 (DE) 10 2022 125 470.4

(51) Int. Cl. F16K 15/06; F25B 41/20

(52) U.S. Cl. CPC F16K 15/063; F25B 41/20

(57) ABSTRACT

Non-return valve for a refrigeration or heat circuit, which is insertable into a connection opening of a connection device or a pipe. The non-return valve has a valve closing member with a closing body. A closing surface of the closing body bears against the valve seat in an initial position of the valve closing member and closes a through opening. The closing body extends from the closing surface in the opposite direction to the travel movement into the working position of the closing body, and the closing body has a convex contour at the free end face end, which is connected to the closing surface by a concave contour.

The invention relates to a non-return valve, in particular for a refrigeration or heat circuit.

WO 2019/219732 A1 discloses a non-return valve for a refrigeration or heat circuit, which can be inserted into an inlet opening of a connection device or a pipe. This non-return valve comprises a one-piece or multi-piece housing with at least one base housing, wherein a feed opening is provided on the inlet side and a discharge opening is provided on the outlet side of the base housing, which are connected to one another by a flow channel.

The base housing comprises at least one guide element through which a valve closing element is guided so that it can be moved from a starting position or closing position to a working position or opening position. A force storage element acts in the opposite direction to the opening movement of the valve closing element. The base housing, the guide element and the force storage element acting on the valve closing member are provided downstream of a valve seat, against which a closing surface of a closing body of the valve closing member rests in the starting position.

The invention is based on the task of forming a non-return valve which enables a reduction in pressure loss in a medium flowing through the non-return valve.

This task is solved by a non-return valve with a valve closing member, which comprises a closing body with a closing surface, preferably adjacent to the closing surface, in particular downstream of the closing surface of the closing body, a sealing element, which, in an initial position, bear against the valve seat and close a flow channel and the closing body extends from the closing surface in a direction opposite to a travel movement of the closing body into the working position and the closing body has a convex contour at a free end face end, which is connected to the closing surface of the closing body by a concave contour. This shape of the closing body, which extends in the opposite direction to the direction of flow of a medium starting from the valve seat or the closing surface, which rests in the valve seat, enables flow optimization to be achieved. In particular, this can reduce turbulence in the medium, especially when flowing towards the valve seat. By increasing the laminar part of the flow in the medium that flows through the open non-return valve, it is possible to reduce the pressure loss. Particularly in the case of non-return valves that are used on a low-pressure side of a refrigeration or heat circuit, a reduction in pressure losses can lead to an improvement in efficiency. This has a positive effect on heat dissipation, for example, which can be increased as a result.

It is preferable that a flowing transition is formed between the convex contour starting from the front end of the closing body and the closing surface of the closing body through the concave contour. Advantageously, gentle gradients are provided in order to achieve smooth flow zones. Furthermore, it is preferable that the convex contour at the free end face end of the closing body merges directly into the concave contour and that the concave contour merges directly into the closing surface. This means that no straight sections are formed. The direct transition between the contours and from the convex contour into the closing surface can further optimize the flow.

The length L of the closing body, starting from the closing surface to the end face of the closing body, is preferably greater than a movement of the closing body from the starting position to the working position. This means that regardless of the opening stroke of the closing body, it is positioned towards or in the inlet opening and acts to promote flow, in particular to reduce pressure loss.

Preferably, the length FR of the guide surface on the guide rib is smaller than a guide length FL between a sleeve of the base housing and a guide section of the closing body pointing towards the base housing. This means that in a first stroke phase, the closing body can be guided between the guide ribs and the valve seat or the inlet opening and in a second stroke phase the closing body can be guided on the base housing. This allows the closing body to be guided over the entire opening stroke of the valve closing element. In addition, the passage at the valve seat can be fully released.

The convex contour formed at the front end of the closing body can be hemispherical or have a parabolic cross-section. Away from the front end of the closing body, the hemispherical contour or parabolic contour can have an equatorial surface with a radius R₁ that is smaller than a cross-sectional area of the closing surface. This can be an optimization variable for reducing the pressure loss.

The concave contour on the closing body, which extends between the convex contour and the closing surface of the closing body, preferably has a radius R₂. This enables a continuous transition. Alternatively, in-stead of the radius R₂, a curve of the concave contour can be provided, which is formed with a changing gradient or a changing radius. In particular, the gradient increases in the direction of the transition to the closing surface of the closing element or the radius becomes smaller. As a result, the closing body widens from its front end in the direction of the closing surface.

According to a further advantageous embodiment, it is provided that the radius R₂ of the concave contour is larger than the radius R₁ of the convex contour.

According to a further advantageous embodiment of the closing body, it may be provided that the radius R₁ of the equatorial surface or the convex contour is smaller than a radius R₃, which determines the cross-sectional area of the closing surface of the closing body.

Advantageously, it can be provided that a length L of the closing body starting from the closing surface to the free end face end of the closing body in relation to the radius R₁ of the convex contour is in a range between 0.25 and 5. A reduction in pressure loss could also be achieved with such a geometry.

Preferably the free end face end of the closing body extends upstream beyond the valve seat after the valve closing member has assumed the working position and preferably the end of the closing body projects into the inlet opening adjacent to the valve seat when the valve closing member is in the working position.

Furthermore, an advantageous design of the closing body can be provided by a ratio between the cross-sectional area of the closing surface and the length of the closing body starting from the closing surface to the end face of the closing body in a range of 3 to 0.3.

In a further preferred embodiment, it is provided that guide ribs extend from the closing surface of the closing body in the direction of the free end face of the closing body or up to the free end face of the closing body. This allows the closing body, which extends against the direction of flow, to be guided centrally relative to the valve seat by the guide ribs even during an opening stroke. As a result, uniform flow conditions can be maintained regardless of the size of the opening stroke.

In particular, two or more guide ribs, preferably aligned at the same circumferential angle to one another, are provided on the closing body of the valve closing element. For example, a star-shaped arrangement or the arrangement in the form of a mathematical plus of the guide ribs can be provided on the closing body.

The guide ribs on the closing body preferably have a guide surface which extend from the closing surface of the closing body in the direction of the free end face of the closing body and are aligned parallel to one another. In particular, it is provided that the guide surfaces of the guide ribs are guided along an inner wall of the inlet opening or in a transition area between a valve seat surface of the valve seat and the inner wall of the inlet opening.

An inflow surface can be formed between the guide surface of the guide rib and the free end face of the closing body. This inflow surface can be straight, rounded or even curved. If the inflow surface is straight, it is preferably inclined at an angle of less than 60° to the longitudinal axis of the valve closing element.

The guide surface of the guide rib preferably extends from the closing surface of the closing body at least as far as the equatorial surface of the convex contour.

Furthermore, it may preferably be provided that the guide surface of the guide rib has a length FR that is smaller than a maximum movement of the closing body or an opening stroke of the closing body from the starting position to the working position.

Alternatively, it can be provided that the guide surface of the guide rib has a length F_{R} that is equal to or greater than a maximum movement of the closing body from the starting position to the working position. This can also provide a guide in the inlet opening of the valve housing at the end face of the closing body, which points in the direction of flow.

Furthermore, it may preferably be provided that at least one guide element is provided on the valve closing member, in particular aligned in the opposite direction to the closing body of the valve closing member, by which the valve closing member is displaceably guided in the base housing, preferably during the entire working stroke of the valve closing member between the working position and the starting position in the base housing. This enables the valve closing member to be guided continuously to the base housing by this at least one guide element during an opening and closing movement of the valve closing member.

According to a preferred embodiment of the non-return valve, it is provided that the valve closing member is guided by the guide ribs in the inlet opening in a first stroke phase from the starting position towards the working position up to an intermediate position and preferably in a second stroke phase from the intermediate position to the working position, the guide ribs are released from the inlet opening and the valve closing member is guided by a guide section of the closing body in the base housing, in particular a sleeve of the base housing. This allows the valve closing member to be guided twice during the entire opening stroke or working stroke. During the second stroke phase from the intermediate position to the working position, the free flow volume can be increased as the guide ribs are no longer guided in the inlet opening.

Preferably, the length F_{R} of the guide surface on the guide rib is smaller than a guide length F_{L} between a sleeve of the base housing and a guide section of the closing body pointing towards the base housing. This allows the closing body to be guided over the entire opening stroke of the valve closing element.

The invention and other advantageous embodiments and further embodiments thereof are described and explained in more detail below with reference to the examples shown in the drawings. The features to be taken from the description and the drawings can be used individually or in any combination in accordance with the invention. It shows:

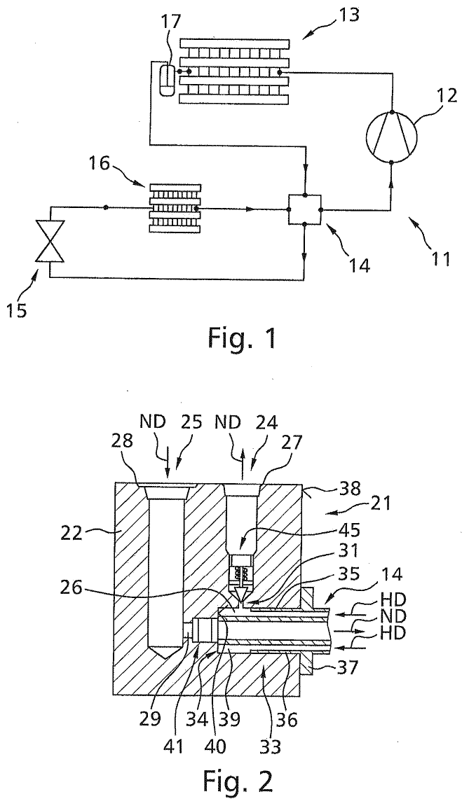

FIG. 1 a schematic representation of a refrigeration circuit

FIG. 2 a schematic sectional view of a connection device with a non-return valve,

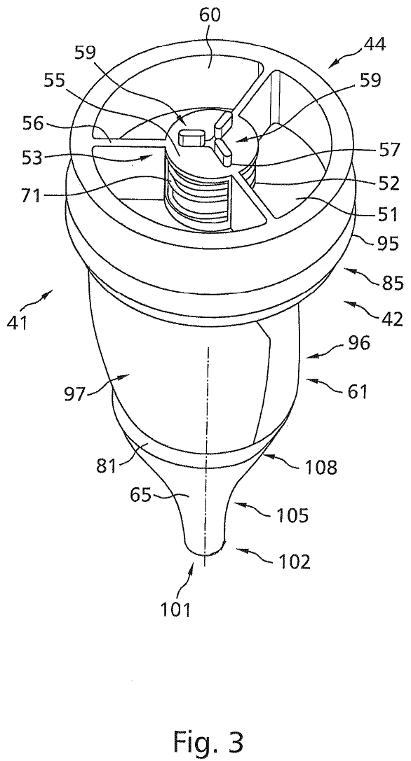

FIG. 3 a perspective view of a first embodiment of the non-return valve

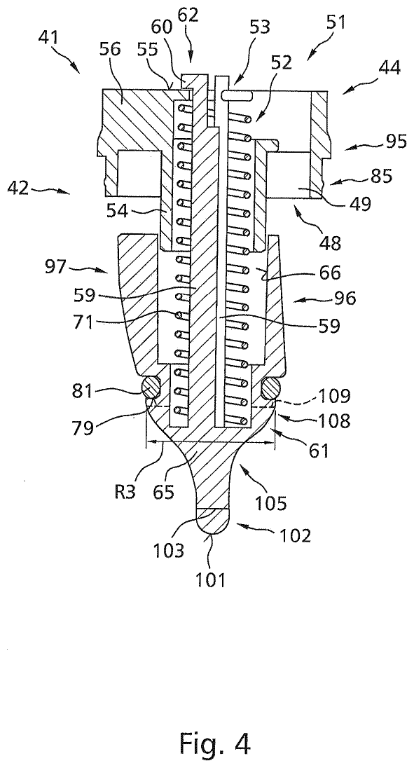

FIG. 4 a schematic sectional view of the non-return valve as shown in FIG. 3,

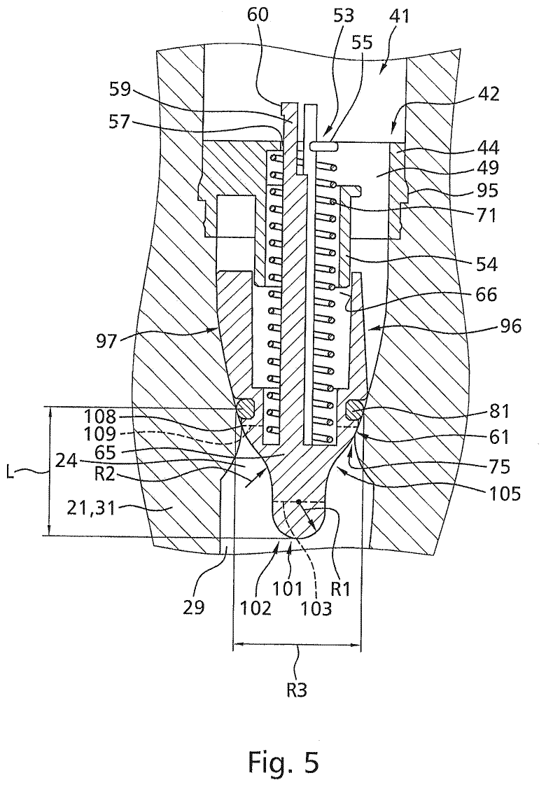

FIG. 5 a schematic sectional view of the non-return valve according to FIG. 3 in an installation situation

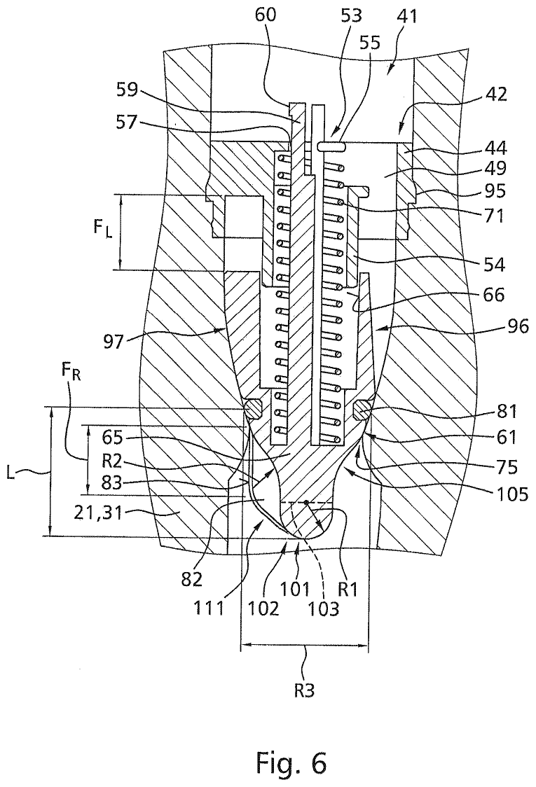

FIG. 6 a schematic sectional view of an alternative embodiment of the non-return valve according to FIG. 3 in an installation situation,

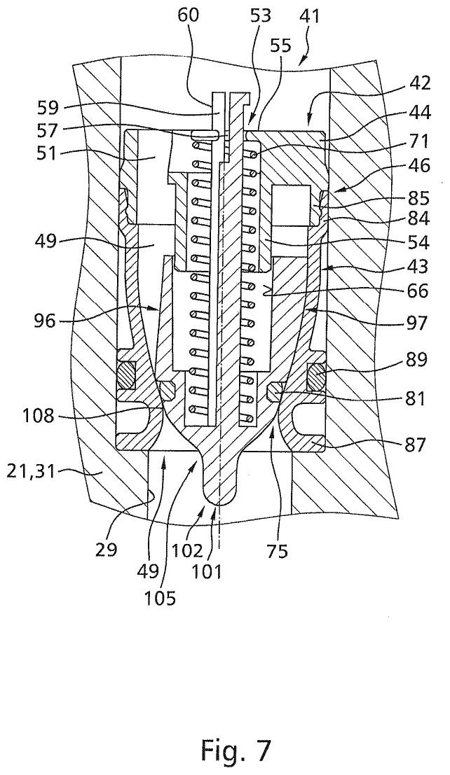

FIG. 7 a schematic sectional view of the non-return valve according to FIG. 3 with a valve housing in a further installation situation,

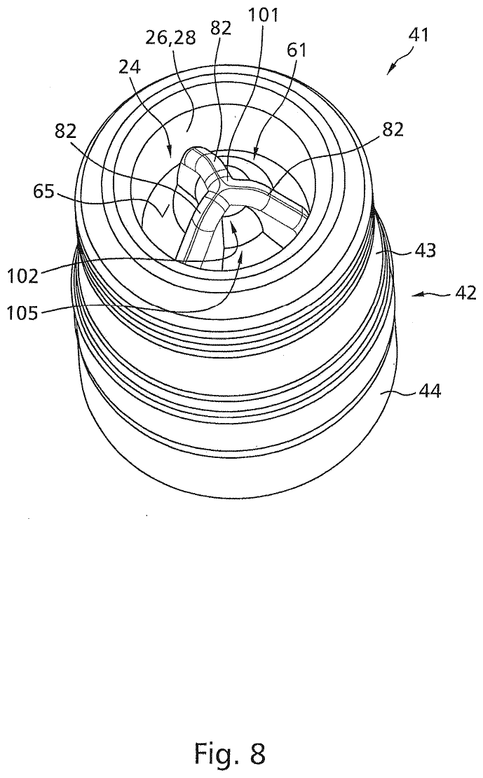

FIG. 8 a perspective view of an alternative embodiment of the non-return valve to FIG. 3,

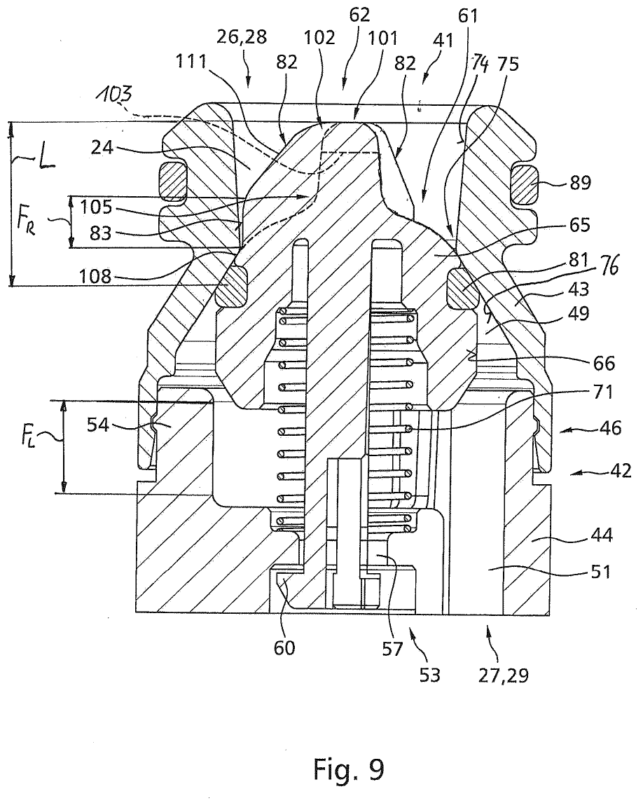

FIG. 9 a schematic sectional view of the non-return valve according to FIG. 8 in an initial position, and

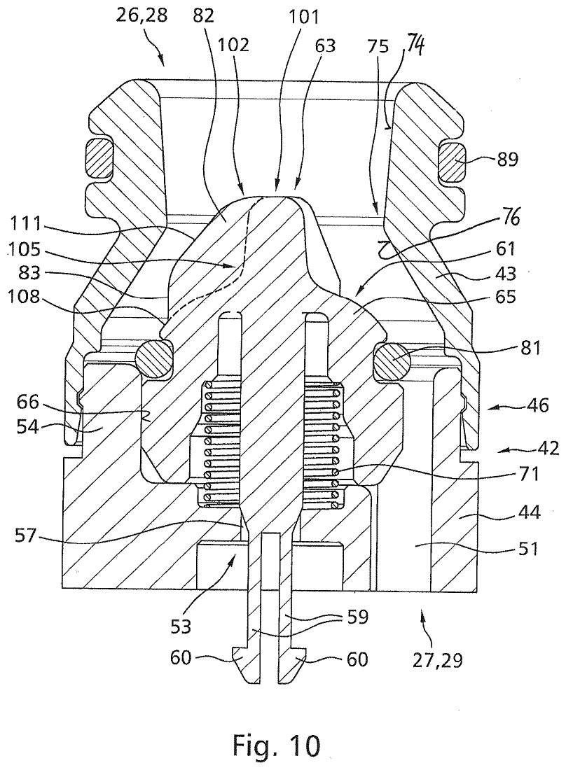

FIG. 10 a schematic sectional view of the non-return valve according to FIG. 8 in a working position.

FIG. 1 shows a conventional design of a refrigeration or heat circuit 11, in particular an air conditioning system, which is preferably used in motor vehicles. A refrigerant is compressed in a compressor 12. This can be R134A, R1234yf or CO2, for example. The compressed refrigerant is fed to a condenser 13, whereby heat is exchanged between the compressed refrigerant and the environment in order to cool the refrigerant. An accumulator 17 or collector can be provided downstream of the condenser 13 in order to separate refrigerant of the gas phase and the liquid phase and simultaneously collect liquid refrigerant. The refrigerant leaving the condenser 13 or accumulator 17 reaches an internal heat exchanger 14. An expansion valve 15 is provided between the internal heat exchanger 14 and a heat exchanger 16. The expansion valve 15 regulates the mass flow of the refrigerant or heat circuit 11 depending on the pressure difference. The high-pressure refrigerant is expanded by the expansion valve 15 and reaches the heat exchanger 16 on the low-Page pressure side. The refrigerant absorbs heat from the environment from the heat exchanger 16. From there, the refrigerant is fed back to the compressor 12 via the internal heat exchanger 14.

When using a connection device 21 as described below according to FIG. 2 in such a refrigeration circuit, there is a deviation in the design of the refrigeration circuit 11 according to FIG. 2 in that the expansion valve 15 is not arranged separately in a pipe section between the internal heat exchanger 14 and the heat exchanger 16, but is integrated into a connection block 22, for example.

The connection device 21 as shown in FIG. 2 comprises an inlet opening 26 of a first through-hole 24, which leads to an outlet opening 27 via a throttle point 31. This outlet opening 27 is connected to an inlet of the heat exchanger 16. Adjacent to this, a second through hole 25 is provided in the connection device 21. An inlet opening 28, which is connected to an outlet of the heat exchanger 16, receives the refrigerant coming from the heat exchanger 14 and feeds it to an outlet opening 29 of the second through-hole 25. The inlet opening 26 of the first through bore 24 and the outlet opening 29 of the second through bore 25 are provided in a common connection bore 33. An end section of an inner heat exchanger 14 can be inserted into this common connecting bore 33. This inner heat exchanger 14 has an outer tube 36, the outer circumference of which rests against the bore section 35 of the connecting bore 33 and extends at least partially into the connecting bore 33. An annular collar 37 or a flange or another connection point is preferably provided in the outer tube 36, which lies against the connection block 22 and fixes the inner heat exchanger 14 to the connection block 22.

The outer tube 36 of the inner heat exchanger 14 extends close to or up to the throttle point 31 without covering it. An inner tube 39 of the inner heat exchanger 14 protrudes from the outer tube 36 and preferably lies against an end face 40, which is formed in the transition region 34 between the outlet opening 29 and the bore section 35. With such an arrangement, the inlet opening 26 of the first through bore 24 is formed by an annular channel between the inner tube 39 and the bore section 35 of the connection bore 33.

In this connection device 21, an expansion valve 45, for example, is connected downstream of the throttle point 31 in the direction of flow of the refrigerant.

A non-return valve 41 can be inserted in the outlet opening 29 of the second through-hole 25 of the connection block 22. Alternatively, a non-return valve 41 can also be inserted into one end of the inner tube 39 of the inner heat exchanger 14. In both cases, the non-return valve 41 adjoins the end face 40 or is arranged adjacent to it. This does not form an additional interface. The non-return valve 41 can also be used in other circuits to secure only one direction of flow of the medium. In particular, the non-return valve 41 is used on the low-pressure side and/or suction side.

FIG. 3 shows a first embodiment of a non-return valve 41.

FIG. 4 shows a schematic sectional view of the non-return valve 41 as shown in FIG. 3.

This non-return valve 41 comprises a base housing 44, which is annular in shape. A guide element 53 is provided in the central area of the base housing 44. This is accommodated, for example, by at least one longitudinal rib 56, preferably by three longitudinal ribs 56. This guide element 53 can comprise a sleeve 54, which is shown in section in FIG. 4. Recesses 52 may be provided between the sleeve 54 and the guide element 53. The guide element 53 comprises at least one aperture 57, preferably three apertures 57, which are connected to one another. The apertures 57 are aligned in a star shape, for example. Preferably, the openings 57 are in longitudinal extension to the longitudinal ribs 56.

The base housing 44 can have a circumferential shoulder 95, which creates a radially outwardly directed projection. This can, for example, serve as a stop for a defined installation of the non-return valve 41. The basic housing 44 can also have a connection section 85. This can be used to attach a valve housing 43 with a connection section 84 arranged thereon to the base housing 44. This arrangement of the valve housing 43 to the base housing 44 is shown in FIG. 7, for example.

The sectional view according to FIG. 4 shows that at least one guide rod 59 extends within the valve closing member 61. This guide rod 59 extends from the closing member 65 in the direction of the base housing 44. A locking element 60 is provided at the end of the guide rod 59. This locking element 60 is directed radially outwards. The guide rod 59 has a dimension in cross-section so that it is guided in the aperture 57. Advantageously, three guide rods 59 are aligned in a star shape. To connect the valve closing element 61 to the base housing 44, the guide rods 59 are moved towards each other so that the locking elements 60 can be guided through the openings 57. The guide rods 59 then return to their starting position. The force storage element 71 acting between the base housing 44 and the valve closing element 61 positions the valve closing element 61 in an initial position 62 relative to the base housing 44. The displacement movement relative to the base housing 44 of the valve closing member 61 is limited by the respective locking element 60 of the at least one guide rod 59. This locking element 60 rests on an outer side of the base 55 on the guide element 53 and limits the displacement movement.

In this starting position 62, the force storage element 71 can be pre-loaded between the base housing 44 and the valve closing element 61. This makes it possible to adjust the opening force of the valve closing element 61. A faster closing movement from a working position to the starting position 62 can also be achieved.

An axial guide is formed between a guide section 66 of the valve closing member 61 and the sleeve 54 of the guide element 53. Preferably, an axially displaceable seal can also be provided between the guide section 66 and the sleeve 54. The valve closing member 61 has a recess 79 adjacent to the valve seat 75, in which a sealing element 81 is arranged.

The closing body 65 of the valve closing element 61 can extend asymmetrically in an area between the sealing element 81 and the base housing 44. For example, a one-sided flattening 96 can be provided, which is opposite a curved course 97. The curved course 97 of the closing body 65 can have a flow-optimized course. An increased flow volume can be achieved by the one-sided flattening 96.

The at least one guide rod 59 can provide an additional guide for the internal force storage element 71. The force storage element 71 is preferably provided inside the sleeve 54 of the guide element and the guide section.

The closing body 65 of the valve closing member 61 extends from the sealing element 81 in the opposite direction to the base housing 44. This closing body 65 has a convex contour 102 at a free end face end 101. Starting from the convex contour 102 and in the direction of the sealing element 81, the convex contour 102 is adjoined by a concave contour 105, which merges into a closing surface 108 of the closing body 65. This closing surface 108 directly adjoins the sealing element 81 or the recess 79 in the closing body 65. The closing surface 108 can be formed into a flat or linear abutment in the valve seat 75. The convex contour 102 can be formed in a semicircular shape and ends in a fictitious equatorial surface 103 remote from the free end face end 101. In the case of a semicircular contour, the equatorial surface 103 corresponds to twice the radius R₁, which determines the curvature of the convex contour 102. Alternatively, it may be provided that the convex contour 102 is formed by a parabola as seen in cross-section, which also ends in the equatorial surface 103. Immediately following this equatorial surface 103, the concave contour 105 extends in the direction of the closing surface 108 of the closing body 65. The concave contour 105 can have a constant curvature with a radius R₍₂₎. The concave contour 105 can also be formed with an increasing gradient in the direction of the closing surface 108.

Adjacent to the sealing element 81, the closing surface 108 comprises a cross-sectional area 109 with a radius R 3. This cross-sectional area 109 corresponds to a cross-sectional area for a through opening 24 in the valve seat 75, in which the valve closing member 61 rests in an initial position and closes the through opening 24.

FIG. 5 shows a schematic view of the non-return valve 41 according to FIGS. 3 and 4 in a first installation situation. In this embodiment, a connection opening of the connection device 21 or a pipe 39 is shown. The connection opening can be an outlet opening and/or inlet opening 26 27, 28, 29. The non-return valve 41 closes the through opening 24 in one direction of flow.

The base housing 44 rests against a step in the connection opening of the connection device 21 with the shoulder 95. As a result, the non-return valve 41 assumes a defined position within the connection opening. The non-return element 41 can be installed with a defined preload force of the energy storage element 71. In this case, the force storage element 71 is subjected to a compressive force between the valve closing member 61 and the base housing 44 and preferably corresponds to the closing force of the valve closing member 61. The valve seat 75 is formed by a constriction in the through opening 24. The closing body 65 and the seal 81 of the valve closing element 61 rest against this valve seat 75. In the starting position 62 of the non-return valve 41 shown in FIG. 5, the through opening 24 is closed.

By changing the distance between the valve seat 75 and the base housing 44 of the non-return valve 11 in the connection opening of the connection device 21, the preload of the energy storage element 71 and thus an opening time can be adjusted.

When pressure is applied to the valve closing element 61 by a medium, the valve closing element 61 is moved in the direction of the base housing 44, preferably after overcoming the set preload force. The valve closing element 61 is moved into a working position 63. As a result, the closing body 65 of the valve closing member 61 lifts off the valve seat 75 and the medium can flow in the direction of the base housing 44. For example, the medium passes through the at least one flow channel 49 through the discharge opening 51.

The closing body 65 rests with its closing surface 108 in an initial position 62 in the valve seat 64. In this embodiment of the non-return valve 41, the closing body 65 extends beyond the valve seat 64 in the opposite direction to the direction of flow.

For example, the closing body 65 may have a radius R₁ for an equatorial surface 103 that is smaller than a radius R₃ of the cross-sectional area in which the closing surface 108 is located. Preferably, R₁ is smaller than 0.5 R₃ or 0.25 R₃. Furthermore, it may preferably be provided that the radius R₁ for the convex contour 102 is smaller than the radius R₂ for the concave contour 105. Furthermore, it may preferably be provided that the length L starting from the sealing element 81 or the closing surface 108 to the free end face end of the closing body 101 is in a range between 0.5 and 5 in relation to the radius R₁. Preferably, it is provided that the length L is greater than an opening stroke of the valve closing member from the starting position 62 into the working position 63. Furthermore, it may be provided that a ratio between the radius R₃ of the cross-sectional area of the closing surface 108 and the length L from the closing surface 108 to the end face end 101 of the closing member 65 is in a range of 4 to 0.25.

FIG. 6 shows a schematic sectional view of an alternative embodiment of the non-return valve 41 according to FIG. 3 in an analogous installation situation according to FIG. 5. This embodiment of the non-return valve 41 corresponds to that in FIGS. 3 to 5. In addition, guide ribs 82 are provided on the closing body 65 of the non-return valve 41 according to FIG. 6. These guide ribs 82 preferably extend from the closing surface 108 in the direction of the free end face end 101 of the closing body 65. Advantageously, two or more guide ribs 82 are provided. These guide ribs 82 have guide surfaces 83, which are preferably aligned parallel to one another. The guide surfaces 83 are aligned coaxially to the longitudinal axis of the valve closing member 61 or to its stroke movement. The guide surfaces 83 can have inflow surfaces 111 which, starting from one end of the guide surface 83, merge into the concave contour 105 or into the convex contour 102. The inflow surface 111 can also merge directly into the end face 101 of the convex contour 102.

The guide surface 83 preferably has a length F(R). The length FR of the guide surface 83 of the guide rib 82 is preferably smaller than a length FL of a guide, which is formed between a sleeve 54 on the base housing 44 and the guide portion 66 on the closing body 65. Furthermore, it is preferably provided that the guide surfaces 83 of the guide ribs 82 have an outer circumference which corresponds to an inner diameter of the through opening 24.

FIG. 7 shows a schematic sectional view of the non-return valve 41 according to FIGS. 3 to 5, which also comprises a valve housing 43. The valve housing 43 comprises the connection section 84, which engages with the connection section 85. The connection section 85 is preferably provided on the outside surrounding the connection section 84. Alternatively, an interchanged arrangement can also be provided. This connection interface 46 can be provided with a plug-in, latching, snap-in, press or screw connection. It can be detachable or non-detachable.

The length of the valve housing 43 or the distance between the valve seat 75 and the connection interface 84 or the base housing 44 can determine a preload force acting on the force storage element 71.

Starting from the base housing 44, the valve housing 43 can have an inner wall section that preferably tapers continuously in cross-section up to the valve seat 75 to form a constriction. The inner cross-section of the valve housing 43 is then progressively enlarged again.

A recessed receptacle for a further sealing element 89 is provided on the outer circumference of the valve housing 43 to seal the connection point in the connection device 21.

An annular collar 87 on the end face of the valve housing 43 rests against a shoulder of the connection device 21. This allows a defined installation position of the non-return valve 41 in relation to the connection opening in the connection device 21 or the pipe 39.

The mode of operation of this non-return valve 41 corresponds to that in FIGS. 3 to 5. Like the embodiment in FIG. 6, the non-return valve 41 shown in FIG. 7 can also have guide ribs 82 with guide surfaces 83.

FIGS. 8 to 10 show a further alternative embodiment of the non-return valve 41 to the embodiments described above.

This embodiment of the non-return valve 41 according to FIGS. 8 to 10 comprises a base housing 44 for receiving the valve closing member 61 with the guide rods 59, which are guided in the at least one guide element 53, according to FIGS. 3 to 5. Furthermore, the non-return valve 41 can comprise a valve housing 43, which can be connected to the base housing 44 by the detachable interface 46.

In this alternative embodiment shown in FIGS. 8 to 10, the design of the closing body 65 of the valve closing member 61 differs from the embodiment shown in FIGS. 3 to 5. However, the shape of the closing body 65 starting from the closing surface 108 up to the free end face end 101 corresponds to the embodiments described above. A sealing element 81 is also provided on the valve closing member 61. The closing surface 108 of the closing member 65 is in contact with a valve seat surface 76 of the valve seat 75 and absorbs the closing force of the energy storage element 71. The sealing element 81 is also in contact with the valve seat surface 76, but only in a sealing manner. This valve seat 75 is preferably in the form of a cone, which widens in the direction of flow from the inlet opening 26, 28 to the outlet opening 27, 29. This enlarges the cross-section of the flow channel 49. This has the advantage that the flow velocity of the medium is reduced as the cross-sectional area increases, thereby reducing the flow pressure losses.

The closing body 65 is preferably designed with a length such that an end face end 101 is positioned within the inlet opening 28 independently of an opening stroke of the valve closing member 61. In this case, the end face end 101 of the closing body 65 can extend up to a transition between the valve seat surface 76 and an inner wall 74 of the inlet opening 26 or beyond in the direction of the inlet opening 26. This embodiment can also apply to the embodiments described above.

The guide ribs 82 are provided on the closing body 65 pointing towards the inlet opening 26, 28. The closing body 65 and the guide ribs 82 arranged thereon with their guide surfaces 83 correspond advantageously to the embodiment according to FIG. 6. During a stroke movement of the valve closing member 61 from the starting position 62 into the working position 63, the guide surfaces 83 of the guide ribs 82 can be guided on the valve seat 75 or the through-opening 24 of the valve housing 43. This provides axial guidance of the valve closing member 61. The guide surface 83 of the guide rib 82 can also be shortened, so that guidance is only provided until the guide section 66 of the closing member 65 is guided through the sleeve 54. Thus, the guidance by the guide ribs 82 only acts during a first opening phase of the valve closing member relative to the valve seat up to an intermediate position. During a further travel path or opening stroke from the intermediate position to the working position 63, the guide acts between the guide section 66 of the closing member 65 and the base body 44 or the sleeve 54 of the base body 44. The further guide formed by the guide rods 59 and the perforation 57 in the base housing 44 acts continuously over the entire stroke path or the travel movement between the working position 63 and the starting position 62. The same applies to the travel movement of the valve closing member 61 from the working position 63 to the starting position 62.

In this alternative embodiment, the guide section 66 and the sleeve 54 do not engage with each other in an initial position 62 of the valve closing member 61. Rather, they are arranged separately from one another. As soon as the guide surfaces 83 of the guide ribs 82 on the closing body 65 disengage from the valve seat 75 during the transition from a first opening phase to a second opening phase of the valve closing member 61, the guide section 66 and the sleeve 54 engage with one another and form an axial guide of the valve closing member 61. In an operating position of the valve closing member 61 as shown in FIG. 10, the guide section 66 and the sleeve 54 engage with one another in such a way that the force storage element 71 is completely enclosed. The flow channel 49 extends outside the valve closure member 61, the guide section 66 and the sleeve 54, so that the flow medium does not come into contact with the energy storage element 71.

The guide ribs 82 provided on the closing body 65 can also have the advantage that they act as so-called rectifiers, i.e. the flow of the medium can be calmed, which in turn enables a reduced loss of flow pressure.

1. Non-return valve for a refrigeration or heat circuit, which is insertable into a connection opening of a connection device or a pipe,
with a one-piece or multi-piece housing, which comprises at least one base housing, wherein a feed opening is provided on the inlet side and a discharge opening is provided on the outlet side of the base housing, which are connected to one another by a flow channel,
with a guide element which is provided on the base housing and through which a valve closing member is displaceably guided, the valve closing member being arranged in an initial position by a force storage element and the valve closing member being displaceable against a force of the force storage element into a working position in the direction of the discharge opening
with a closing body which is arranged on the valve closing member and has a closing surface which, in an initial position of the valve closing member, bears against a valve seat of the connecting device or of the pipe or a valve housing of the housing, and closes a through-opening,
with a sealing element arranged adjacent to the closing body, which rests against the valve seat and
the base housing the guide element and the force storage element acting on the valve closing member are provided downstream of the valve seat,
wherein the closing body extends from the closing surface in the opposite direction to a travel movement of the valve closing member from the starting position into the working position, and
wherein the closing body has a convex contour at the free end face end, which is connected to the closing surface by a concave contour
wherein the guide ribs extend from the closing surface of the closing body in the direction of the free end face end of the closing body or up to the free end face end of the closing body.

2. Non-return valve according to claim 1, wherein a flowing transition is formed between the convex contour and the closing surface by the concave contour.

3. Non-return valve according to claim 1, wherein the convex contour merges directly into the concave contour and the concave contour merges directly into the closing surface of the closing body.

4. Non-return valve according to claim 1, wherein a length L of the closing body starting from the closing surface up to the free end face end of the closing body is greater than a travel movement of the valve closing member from the starting position into the working position.

5. Non-return valve according to claim 1, wherein the closing body is formed hemispherically or with a parabolic cross-section at its free end face end and in that an equator surface with a radius R₁, which is smaller than a radius R₃ of a cross-sectional area of the closing surface, is formed remote from the free end face end by the convex contour.

6. Non-return valve according to claim 1, wherein the concave contour between the convex contour and the closing surface is formed by a radius R₂ or by a curve with a changing gradient or a changing radius.

7. Non-return valve according to claim 4, wherein a length L of the closing body, starting from the closing surface to the free end face end of the closing body is in a range between 0.25 and 5 in relation to the radius R₁ of the equator surface.

8. Non-return valve according to claim 1, wherein the free end face end of the closing body extends upstream beyond the valve seat after the valve closing member has assumed the working position and the end of the closing body in the working position of the valve closing member projects into the inlet opening adjacent to the valve seat.

9. Non-return valve according to claim 4, wherein a ratio between the radius R₃ of the cross-sectional area of the closing surface and the length L of the closing body, starting from the closing surface to the free end face end of the closing body, is in a range of 3 to 0.3.

10. (canceled)

11. Non-return valve according to claim 1, wherein two or more guide ribs, aligned at the same circumferential angle to one another, are provided on the closing body.

12. Non-return valve according to claim 1, wherein the guide ribs have a guide surface which, starting from the closing surface of the closing body, extend in the direction of the free end face end of the closing body and are aligned parallel to one another, and is guided along an inner wall of the inlet opening or in a transition region between a valve seat surface of the valve seat and the inner wall of the inlet opening.

13. Non-return valve according to claim 12, wherein between the guide surface of the guide rib and the free end face end of the closing body an inflow surface is formed which is straight, curved or rounded.

14. Non-return valve according to claim 12, wherein the guide surface of the guide rib extends at least from the closing surface of the closing body to the equator surface on the closing body.

15. Non-return valve according to claim 12, wherein the guide surface of the guide rib has a length F_{R} which is smaller than a maximum travel movement of the closing body from the starting position into the working position.

16. Non-return valve according to claim 12, wherein the guide surface of the guide rib has a length F_{R} which is equal to or greater than a maximum travel movement of the closing body from the starting position to the working position.

17. Non-return valve according to claim 1, wherein in that the valve closing member is guided in a first stroke phase from the starting position in the direction of the working position up to an intermediate position by the guide ribs in the inlet opening and in a second stroke phase from the intermediate position up to the working position the guide ribs come free from the inlet opening and the valve closing member is guided by a guide section of the closing body and a guide section of the base housing.

18. Non-return valve according to claim 17, wherein the length F_{R} of the guide surface on the guide rib is smaller than a guide length F_{L} between the sleeve of the base housing and a guide section of the closing body which faces the base housing.

19. Non-return valve according to claim 1, wherein the sealing element is arranged downstream of the closing surface of the closing body and the closing force of the force storage element is transmitted to the valve seat via the closing surface of the closing body and/or the sealing element only bears against the valve seat in a sealing manner.

20. Non-return valve according to claim 1, wherein at least one guide element is provided on the valve closing member aligned in the opposite direction to the closing body by means of which guide element the valve closing member is displaceably guided in the base housing.

21. Non-return valve according to claim 6, wherein the radius R₂ of the convex contour is greater than the radius R₁ of the convex contour.
